(19) United States
(12) Patent Application Publication
(10) Pub. No.: US 2026/0103153 A1
(43) Pub. Date: Apr. 16, 2026

(54) AIRCRAFT WIRE HARNESS

(71) Applicant: HarcoSemco LLC, Branford, CT (US)

(72) Inventors: Mark Jaeger, North Branford, CT (US); Omar Rubio, Branford, CT (US)

(21) Appl. No.: 19/360,207

(22) Filed: Oct. 16, 2025

Related U.S. Application Data
(60) Provisional application No. 63/707,947, filed on Oct. 16, 2024.

(51) Int. Cl. B60R 16/02; H01B 7/00; H01B 13/012

(52) U.S. Cl. CPC B60R 16/0215; H01B 7/0045; H01B 13/012

(57) ABSTRACT

A wire harness for an aircraft includes a high temperature section including one or more high temperature branches, each of the one or more high temperature branches including one or more cable bundles, one or more lengths of filler, and an overbraid surrounding the one or more cable bundles and the one or more lengths of filler, the overbraid including one or more secondary layers of overbraiding at predefined locations along the overbraid, a low temperature section including one or more low temperature branches, and a transition assembly separating the high and low temperatures sections.

### RELATED APPLICATIONS

This application claims the benefit of U.S. Provisional Application No. 63/707,947 filed October 16, 2024, which is hereby incorporated herein by reference.

### FIELD OF THE DISCLOSURE

The present application relates generally to a wire harness, and more particularly to a wire harness for an aircraft.

### BACKGROUND

Modern aircraft that are operating at high speeds are known to be subjected to great stress, strain and shock. Accordingly, a thermocouple apparatus in the aircraft must not only be adapted to elevated states and rapid changes of temperature, but it must also be characterized by robust design and construction to reliably operate at these severe environmental conditions. Additionally, the thermocouples have to be located at points spaced about the periphery of the gas turbine tail cone or pipe in order to obtain meaningful temperature measurements. Furthermore, the thermocouples are mounted about the tail cone or pipe of the gas turbine in such a way that the failure of any one or more of the thermocouples does not affect or nullify the functioning of any other of the thermocouples, and so that their total or average indication is utilized as the significant value or measurement of gas stream temperature.

### SUMMARY

According to an aspect, a wire harness for an aircraft is provided including a high temperature section including one or more high temperature branches, each of the one or more high temperature branches including one or more cable bundles, one or more lengths of filler, and an overbraid surrounding the one or more cable bundles and the one or more lengths of filler, the overbraid including one or more secondary layers of overbraiding at predefined locations along the overbraid, a low temperature section including one or more low temperature branches, and a transition assembly separating the high and low temperatures sections.

The one or more secondary layers of overbraiding include a plurality of secondary layers of overbraiding spaced from one another along a length of the overbraid.

The one or more secondary layers are formed by back-braiding.

The high temperature branch includes a split forming first and second high temperature branches, and wherein each of the first and second high temperature branches has an overbraid with one or more secondary layers of overbraiding.

Each of the first and second high temperature branches includes a plurality of secondary layers of overbraiding spaced from one another along a length of the overbraid.

The transition assembly includes a junction configured to be coupled to a plate in the aircraft, the junction including a body having a first end, a second end, and a passage extending therethrough between the first and second ends, wherein the one or more cable bundles and the one or more lengths of filler extend into the passage.

The overbraid is coupled to the second end of the body.

The junction additionally includes a flange surrounding the body and configured to abut a side of the plate.

The flange includes cutouts on opposite sides thereof extending inward toward the body.

According to another aspect, a wire harness for an aircraft is provided that includes a junction configured to be coupled to a plate in the aircraft, the junction including a body having a first end, a second end configured to extend through an opening in the plate, and a passage extending therethrough between the first and second ends, one or more cable bundles extending into the passage from the second end of the body, one or more lengths of filler extending into the passage from the second end of the body, and an overbraid coupled to the second end of the body surrounding the one or more cable bundles and the one or more lengths of filler.

The one or more cable bundles includes two cable bundles and the one or more lengths of filler include two lengths of filler.

The lengths of filler extend into the passage and terminate within the passage.

The lengths of filler are fiberglass filler.

The wire harness further includes one or more secondary layers of overbraiding at predefined locations along the overbraid.

The one or more secondary layers of overbraiding include a plurality of secondary layers of overbraiding spaced from one another along a length of the overbraid.

The one or more secondary layers are formed by back-braiding.

The junction additionally includes a flange surrounding the body configured to abut a side of the plate.

The flange includes cutouts on opposite sides thereof extending inward toward the body.

The body of the junction includes stepped regions at the second end that receive the overbraid, and wherein the overbraid is secured to the second end at the stepped regions by respective clamps.

According to still another aspect, a method of forming a high temperature section of a wire harness is provided, the high temperature section including one or more high temperature branches including one or more cable bundles and one or more lengths of filler. The method includes performing a forward braid in a first direction a first predetermined distance around the one or more cable bundles and one or more lengths of filler to form an overbraid, performing a reverse braid in a second direction opposite the first direction a second predetermined distance, and performing a forward braid in the first direction the second predetermined distance forming one or more additional layers of braiding.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof.

FIG. 1 is a perspective view of an exemplary wire harness.

FIG. 2 is an exploded view of a transition assembly of the wire harness and of a mounting plate.

FIG. 3 is a perspective view of the transition assembly coupled to the mounting plate.

FIG. 4 is another perspective view of the transition assembly coupled to the mounting plate.

FIG. 5 is a perspective view of a junction of the transition assembly.

FIG. 6 is a perspective view of another exemplary wire harness.

FIG. 7 is a perspective view of a junction of a transition assembly of the wire harness.

FIG. 8 is a perspective view of a wire harness.

FIG. 9 is a perspective view of a branch of the exemplary wire harness.

FIG. 10 is a side view of a branch of the wire harness showing a split in the branch.

FIG. 11 is and end view of another transition assembly.

FIG. 12 is a cross-section view of another wire harness.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

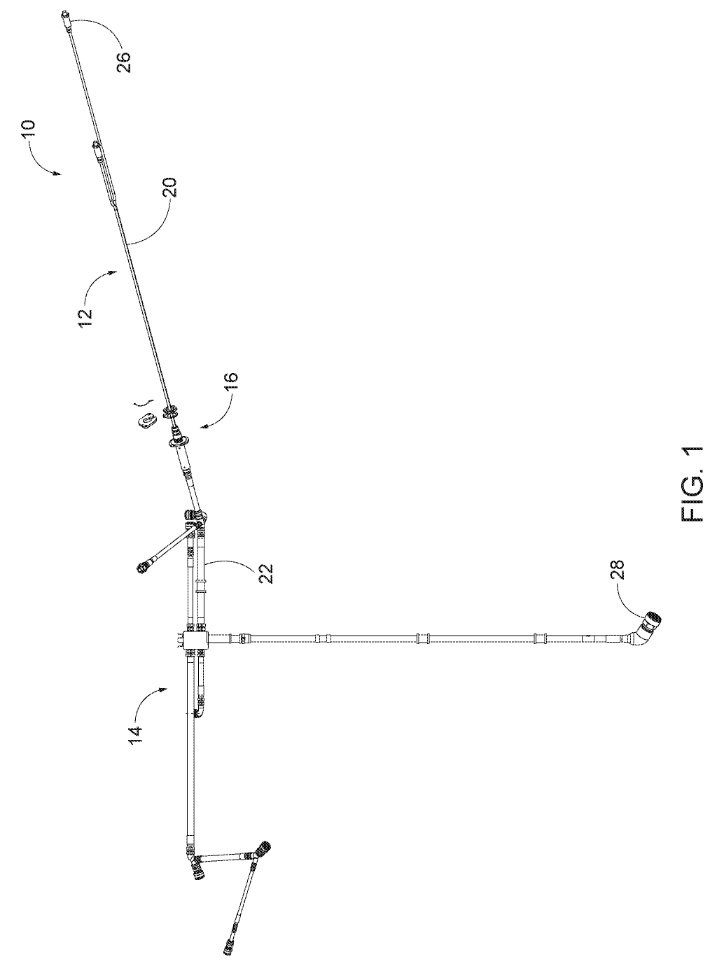

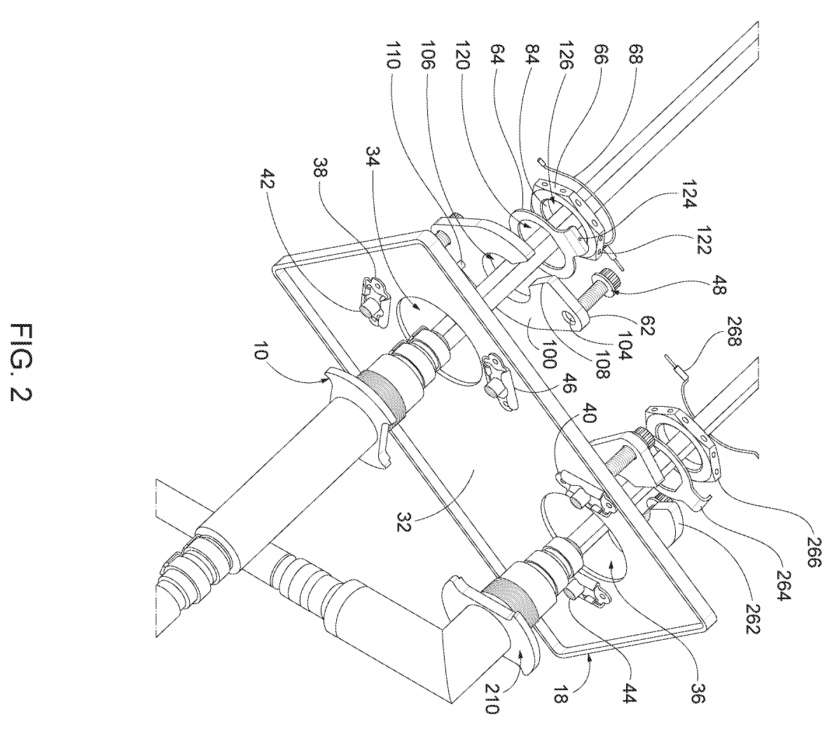

Turning initially to FIG. 1, a wire harness, such as a thermocouple wire harness for an aircraft is shown generally at reference numeral 10. The wire harness 10 is designed to be installed around the turbine engine of the aircraft to obtain temperature measurements from the engine. The wire harness 10 includes a high temperature section 12 and a low temperature section 14 separated by a transition assembly 16 configured to be coupled to a mounting plate 18 (FIG. 2) in the aircraft. The design of the wire harness 10 allows the high temperature section 12 to be fed through the mounting plate 18 during installation and then the transition assembly 16 attached rather than coupling separate wire harnesses together at the mounting plate 18.

The high temperature section 12 includes a high temperature branch 20, and the low temperature section 14 includes a low temperature branch 22, which may include a plurality of branches 24. The branch 20 terminates at one or more connectors 26, and as shown a pair of connectors 26 configured to be coupled to probe assemblies on the engine, and the branches 24 terminate at connectors 28 where wires disposed in the branches 22 can be coupled to thermocouples.

Turning additionally to FIGS. 2-4, the mounting plate 18 will be described in detail. The mounting plate 18 includes a first side 30, for example a side oriented towards the high temperature side of the engine, and a second side 32, for example a side oriented toward the low temperature side of the engine. The mounting plate 18 also includes a first opening 34 through which the high temperature section 12 of the wire harness 10 is fed during installation, and a second opening 36 laterally spaced from the first opening 34 through which a high temperature section of a second wire harness, for example a high temperature section 212 of wire harness 210 discussed below, is fed during installation. Surrounding each of the first and second openings 34 and 36 is a respective orientation opening 38, 40 and a respective pair of attachment openings 42, 44. Each attachment opening 42, 44 is abutted on the second or low temperature side 32 of the mounting plate by a clip 46 configured to receive a fastener 48 to secure a flange assembly of the transition assembly 16 to the mounting plate 18.

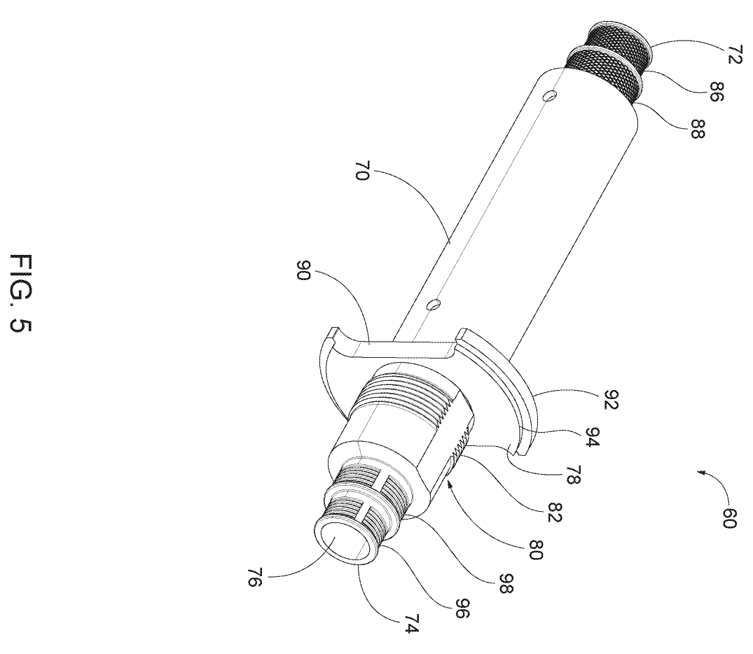

Turning to FIG. 5 in addition to FIGS. 2-4, the transition assembly 16 will be described in detail. The transition assembly 16 includes a junction 60, a slotted flange 62, a washer 64, a nut 66, and a cable 68. The junction 60 includes a body 70 having a first end 72 configured to be coupled to the low temperature branch 22, a second end 74 configured to be coupled to the high temperature branch 20, and a passage 76 extending therethrough for wires to pass through the junction 60. The junction 60 also includes a flange 78 surrounding the body 70 configured to abut the low temperature side 32 of the mounting plate 18, and an attachment area 80 on the body 70 between the second end 74 and the flange 78. The attachment area 80 may include threads 82 configured to mate with corresponding threads 84 on the nut 66 to secure the junction 60 to the mounting plate 18.

The flange 78 includes cutouts or scallops 90 on opposite sides thereof that extend inward toward the body 70 reducing a width of a portion of the flange 78 in a longitudinal direction perpendicular to a longitudinal direction of the body 70. The cutouts 90 allow the junction 60 to be rotated and otherwise moved during installation in the aircraft to provide clearance and avoid interference with bolts, fittings, and other components installed around the engine of the aircraft. The flange 78 also can include abutment regions 92 above and below the cutouts 90 providing increased surface area for the flange 78 to increase the contact between the flange 78 and the mounting plate 18 around the opening 34, and ledges 94 configured to abut inner surfaces of the mounting plate 18 in the opening 34.

The body 70 can also include stepped regions 86 and 88 at the first end 72 and stepped regions 96 and 98 at the second end 74. The stepped regions have differing diameters from one another to receive sheaths or overbraiding of the wire harness. Suitable bands of the wire harness may be placed over the sheaths to secure the sheaths to the respective stepped region 86, 88, 96, 98.

The slotted flange 62 includes a first side 100 configured to abut the high temperature side 30 of the mounting plate 18, a second side 102 configured to be abutted by the washer 64, a pair of openings 104, a through hole 106, a slot 108 into the through hole 106, and an orientation projection 110 configured to be received in the orientation opening 38 in the mounting plate 18 to align the slotted flange 62. The pair of openings 104 are configured to receive the fasteners 48 to allow the fasteners 48 to be coupled to the clips 46. The through hole 106 is configured to allow wires to extend therethrough and the slot 108 extends from the through hole 106 to an outer edge of the slotted flange 62 to allow the slotted flanged 62 to be placed around the wires once positioned by the mounting plate 18.

The washer 64 includes a through hole 120 to allow wires to extend therethrough and a projection 122 extending from a side and having an opening 124 for receiving the cable 68. Similarly, the nut 66 includes a through hole 126 to allow wires to extend therethrough and openings 128 in the side for receiving the cable 68. The cable 68 is woven through at least two of the openings 128 and has one end extending through the opening 124 in the projection 122 and another end extending out one of the openings 128 to prevent the nut 66 from uncoupling from the junction 60 during use, for example due to vibration.

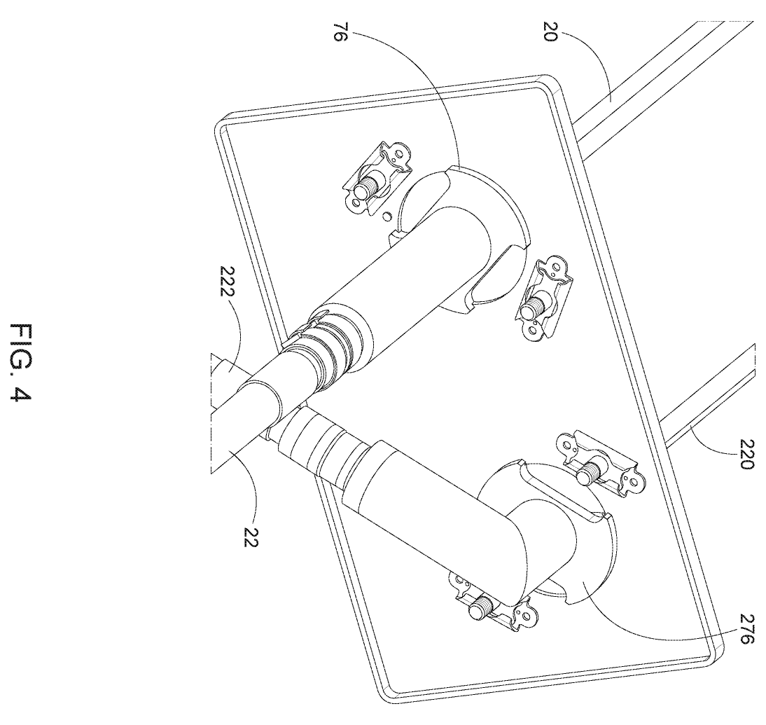

To install the wire harness 10 in the aircraft, the high temperature branch 20 and connectors 26 are advanced through the first opening 34 in the mounting plate 18 and components of the harness 10, including the flange 78 of the junction 60, are navigated around the engine components to position the harness components in their desired locations. The cutouts 90 of the flange 78 enable the junction 60 to be navigated to position without interference by engine components. The junction 60 is positioned such that the second end 74 of the junction 60 extends through the first opening 34 in the mounting plate 18 into the high temperature area of the engine, and the flange 78, including the abutment regions 92, abut the second side 32 of the mounting plate 18 around the first opening 34 as shown in FIG. 4. The washer 64 and the nut 66 can then be advanced over the connectors 26, or be positioned at any suitable time, such that the high temperature branch 20 extends through the through holes 120 and 126 in the washer 64 and the nut 66 respectively.

The slotted flange 62 can then be positioned, or be positioned at any suitable time, by advancing the high temperature branch 20 through the slot 108 to be surrounded by the through hole 106. The slotted flange 62 is then positioned relative to the mounting plate 18 by aligning the orientation projection 110 with the orientation opening 38 in the mounting plate. The slotted flange 62 is then positioned such that the first side 100 of the slotted flange abuts the first side 30 of the mounting plate 18, the orientation projection 110 is disposed in the orientation opening 38, and the openings 104 are aligned with the attachment openings 42 that surround the first opening 34. The fasteners 48 can then be inserted through the openings 104 and 42 and secured to the respective clips 46 to couple the slotted flange 62 to the mounting plate 18.

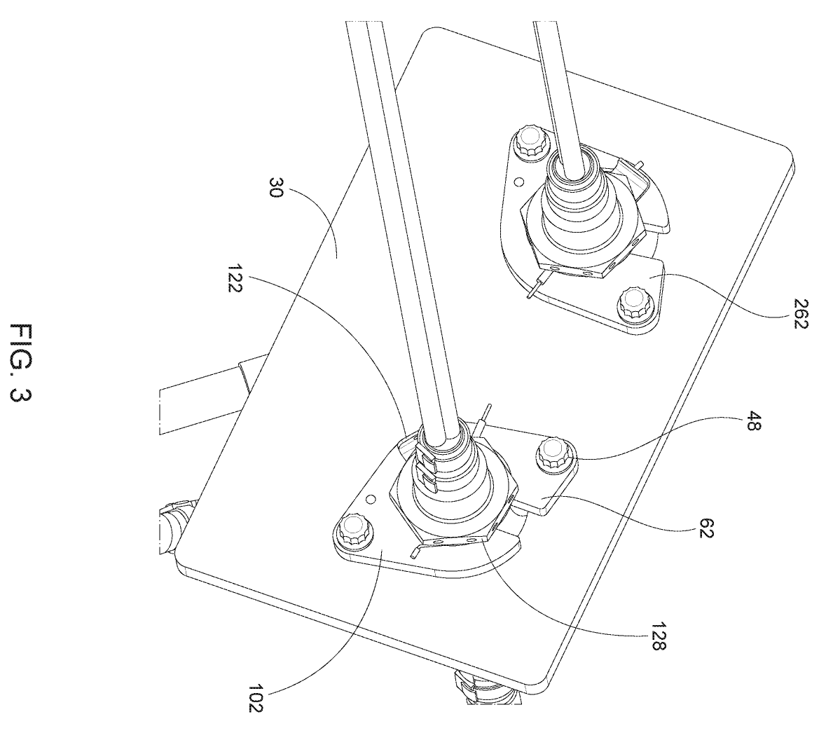

When the slotted flange 62 is secured to the mounting plate 18, the second end 74 of the junction 60 extends through the through hole 106 in the slotted flange 62 or can be later positioned to extend through the through hole 106. The washer 64 can then be advanced to abut the second side 102 of the slotted flange 62 over the body 70 of the junction 60 and the nut 66 can be advanced to abut the washer 64 over the body 70. The nut 66 is rotated such that the threads 84 engage the threads 82 on the attachment area 80 of the body to couple the nut 66 to the junction 60, thereby securing the transition assembly 16 to the mounting plate 18 as shown in FIG. 3. The cable 68 can then be inserted into the opening 124 and openings 128 to prevent the nut from uncoupling from the attachment area 80.

It will be appreciated that the various attachment steps, such as the securing of the fasteners 48, the coupling of the nut 66 to the junction 60, etc., may be performed in any suitable order.

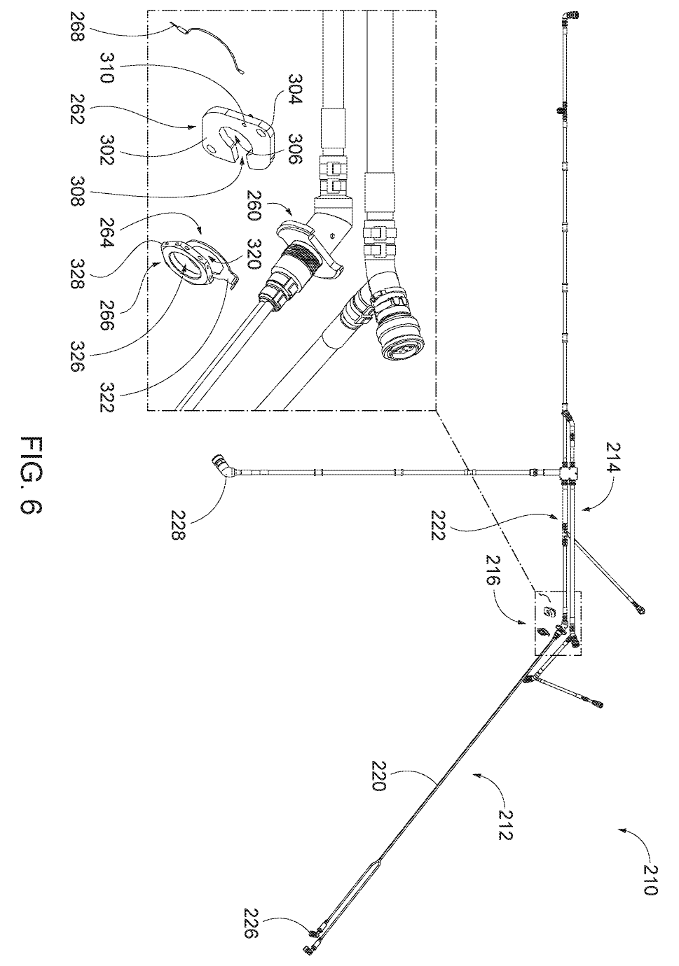

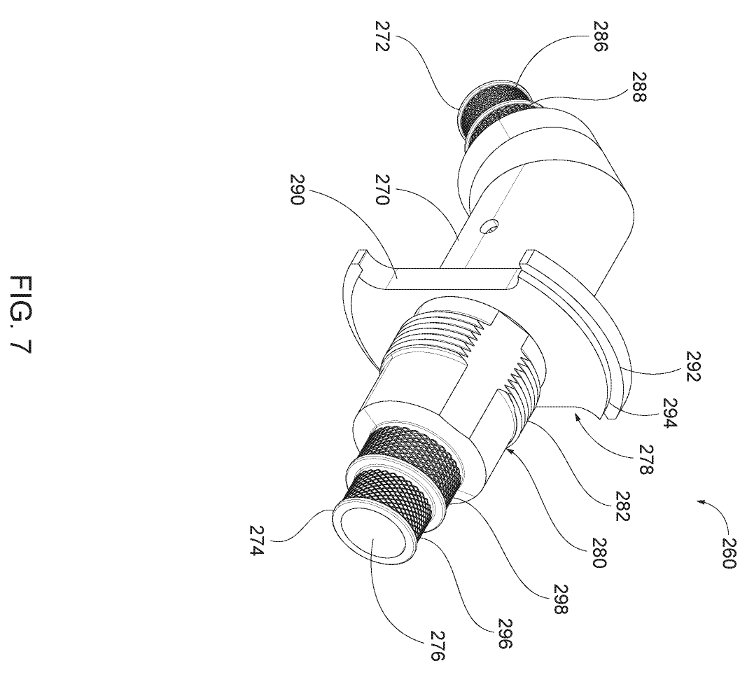

Turning now to FIGS. 6 and 7, an exemplary embodiment of the wire harness is shown at 210. The wire harness 210 is substantially the same as the above-referenced wire harness 10, and consequently the same reference numerals but indexed by 200 are used to denote structures corresponding to similar structures in the wire harnesses. In addition, the foregoing description of the wire harness 10 is equally applicable to the wire harness 210 except as noted below.

Turning initially to FIG. 6, the wire harness 210 includes a high temperature section 212 and a low temperature section 214 separated by a transition assembly 216 configured to be coupled to the mounting plate 218 in the aircraft. The high temperature section 212 includes a high temperature branch 220, and the low temperature section 214 includes a low temperature branch 222, which may include a plurality of branches 222. The branch 220 terminates at one or more connectors 226, and as shown a pair of connectors 226 configured to be coupled to probe assemblies on the engine, and the branches 222 terminate at connectors 28 where wires disposed in the branches 222 can be coupled to thermocouples.

Turning additionally to FIG. 7, the transition assembly 216 will be described in detail. The transition assembly 16 includes a junction 260, a slotted flange 262, a washer 264, a nut 266, and a cable 268. The junction 260 includes a body 270 having a first end 272 configured to be coupled to the low temperature branch 222, a second end 274 configured to be coupled to the high temperature branch 220, and a passage 276 extending therethrough for wires to pass through the junction 260. An area of the junction 260 is angled from the body 270 toward the first end 272 to allow for the junction 260 to fit within the aircraft. The junction 260 also includes a flange 278 surrounding the body 270 configured to abut the low temperature side 32 of the mounting plate 18, and an attachment area 280 on the body 270 between the second end 274 and the flange 728. The attachment area 280 may include threads 282 configured to mate with corresponding threads on the nut 266 to secure the junction 260 to the mounting plate 18.

The flange 278 includes cutouts or scallops 290 on opposite sides thereof that extend inward toward the body 270 reducing a width of a portion of the flange 278 in a longitudinal direction perpendicular to a longitudinal direction of the body 270. The cutouts 290 allow the junction 260 to be rotated and otherwise moved during installation in the aircraft to provide clearance and avoid interference with bolts, fittings, and other components installed around the engine of the aircraft. The flange 278 also can include abutment regions 292 above and below the cutouts 290 providing increased surface area for the flange 278 to increase the contact between the flange 278 and the mounting plate 18 around the opening 36, and ledges 294 configured to abut inner surfaces of the mounting plate 18 in the opening 36.

The body 270 can also include stepped regions 286 and 288 at the first end 272 and stepped regions 296 and 298 at the second end 274. The stepped regions have differing diameters from one another to receive sheaths or overbraiding of the wire harness. Suitable bands of the wire harness may be placed over the sheaths to secure the sheaths to the respective stepped region 286, 288, 296, 298.

The slotted flange 262 includes a first side configured to abut the high temperature side 30 of the mounting plate 18, a second side 302 configured to be abutted by the washer 264, a pair of openings 304, a through hole 306, a slot 308 into the through hole 306, and an orientation projection 310 configured to be received in the orientation opening in the mounting plate 18 to align the slotted flange 262. The pair of openings 304 are configured to receive the fasteners to allow the fasteners to be coupled to the clips. The through hole 306 is configured to allow wires to extend therethrough and the slot 308 extends from the through hole 306 to an outer edge of the slotted flange 262 to allow the slotted flanged 262 to be placed around the wires once positioned by the mounting plate 18.

The washer 264 includes a through hole 320 to allow wires to extend therethrough and a projection 322 extending from a side and having an opening for receiving the cable 268. Similarly, the nut 266 includes a through hole 326 to allow wires to extend therethrough and openings 328 in the side for receiving the cable 268. The cable 268 is woven through at least two of the openings 328 and has one end extending through the opening in the projection 322 and another end extending out one of the openings 328 to prevent the nut 266 from uncoupling from the junction 260 during use, for example due to vibration.

The transition assembly 216 may be installed in a same manner as the transition assembly 16. In an implementation, the transition assembly 16 and the transition assembly 216 may be coupled to the mounting plate 18. In another implementation, two transition assemblies 16 may be installed or two transition assemblies 216 may be installed.

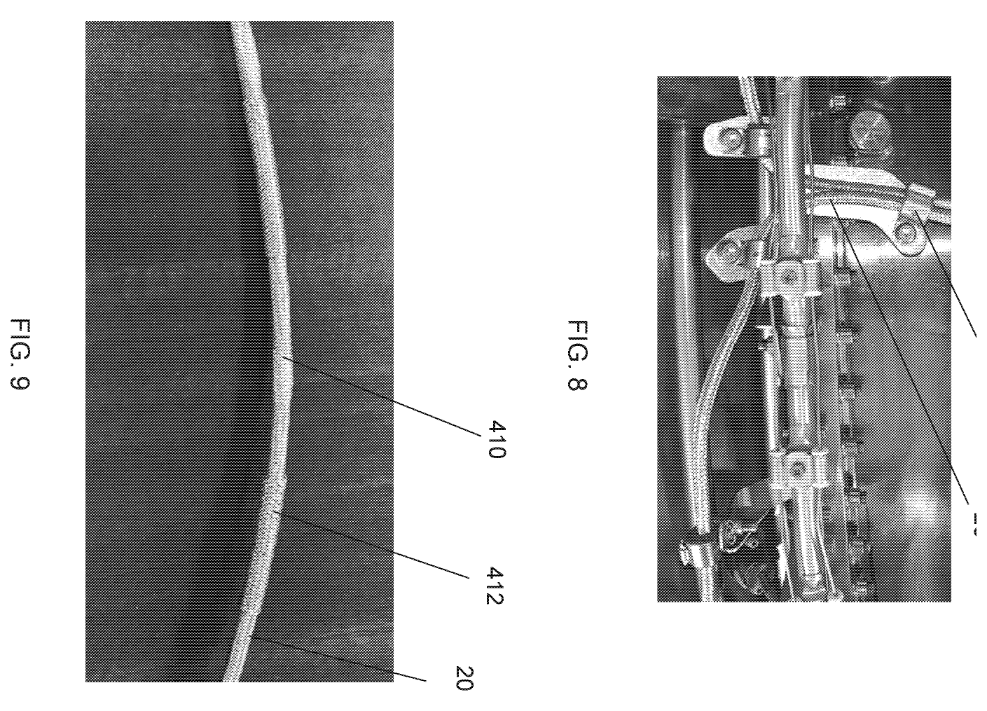

Turning now to FIG. 8, the various branches of the wire harness may include an overbraid surrounding wires and filler for abrasion protection, such as a stainless steel overbraid. In the high temperature branch 20, additional protection may be provided at each location where the branch 20 is coupled to the aircraft, for example at areas where the branch is coupled by a clamp, such as at clamp 400. The additional protection may also serve to mark a location for a clamp 400 so that an installer knows where to place a clamp relative to the harness during installation.

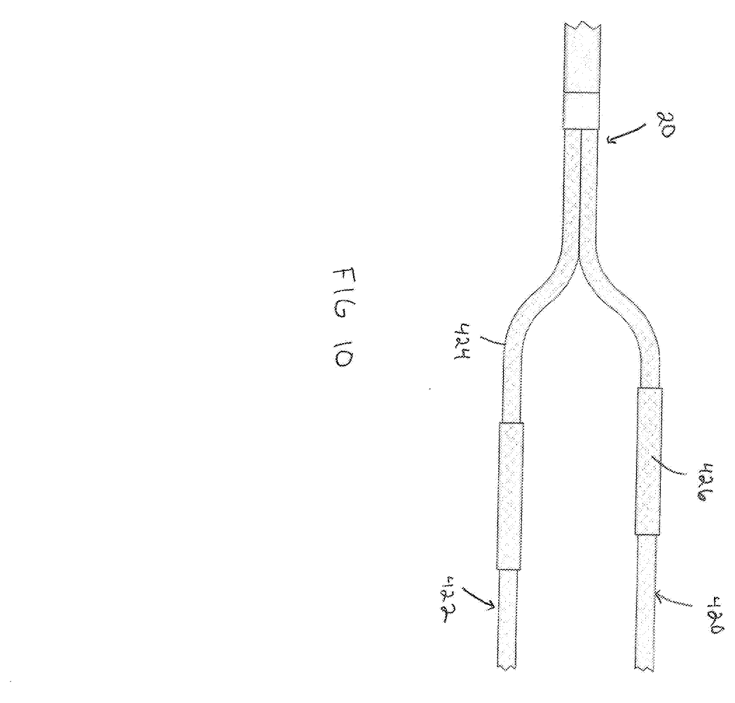

As shown in FIG. 9, a reverse braid or back-braid is performed in the braiding procedure. During the braiding procedure, an overbraid 410 is provided, and one or more additional or secondary layers 412 of braiding are added to the overbraid 410 at the locations for the clamps to provide additional abrasion protection and to mark the locations for the clamps in the high temperature branches. As such, a plurality of additional or secondary braiding layers 412 may be provided along a length of the branch as shown in FIG. 9. For example, during the braiding procedure, after a forward braid to a location of the harness for a clamp, the process is reversed a predetermined distance, and then the process moves forward again adding one or more additional layers of braiding at the location for the clamp. Using a reverse braid has no change to the electrical circuit, transition assembly structure, material termination or dimensional characteristics of the finished harness. The reverse braid also has no appreciable effects on weight, balance, structural strength, operational characteristics, or other characteristic adversely affecting the products airworthiness, but will improve reliability of the harness and will not slide like tape or a sleeve. It will be appreciated that one or more additional or secondary layers of braiding may also be applied to other areas of the wire harness, such as the low temperature branches.

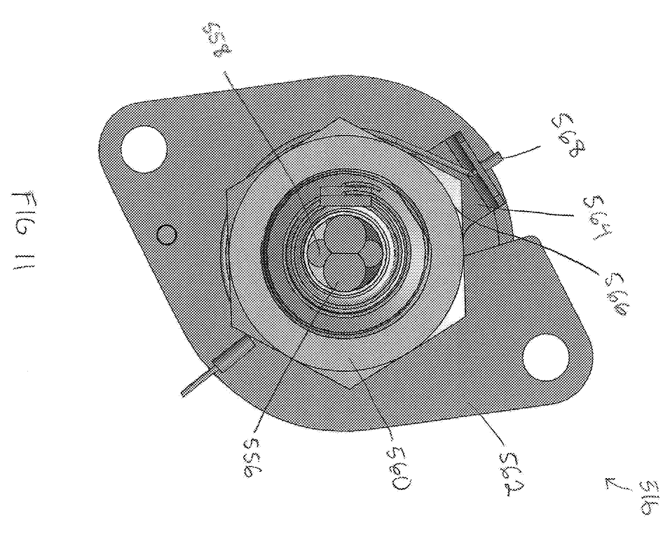

Turning additionally to FIG. 10, the high temperature branch 20 is shown with a split in the branch forming first and second branches 420 and 422. Each of the branches 420 and 422 has overbraid 424 and one or more additional or secondary braiding layers 426 at locations for clamps. In an implementation, each of the first and second branches 420 and 422 has a plurality of additional or secondary braiding layers 426.

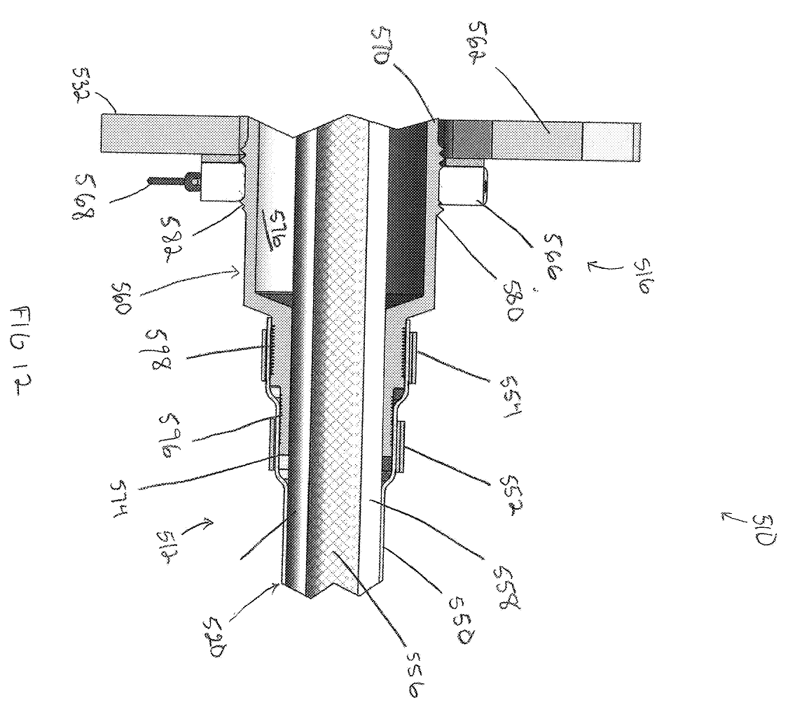

Turning now to FIGS. 11 and 12, an exemplary embodiment of the wire harness is shown at 510. The wire harness 510 is substantially the same as the above-referenced wire harness 10, and consequently the same reference numerals but indexed by 500 are used to denote structures corresponding to similar structures in the wire harnesses. In addition, the foregoing description of the wire harness 10 is equally applicable to the wire harness 510 except as noted below. Further, it will be appreciated that the below junction 560 may be substantially the same as junction 60 or 260, and that the break line in FIG. 12 represents that the first end of the junction 560 may be similar to either of junctions 60 or 260.

The wire harness 510 includes a high temperature section 512 and a low temperature section separated by a transition assembly 516 configured to be coupled to a mounting plate in the aircraft. The high temperature section 512 includes a high temperature branch 520, and the low temperature section includes a low temperature branch, which each may include a plurality of branches.

The transition assembly 516 includes a junction 560, a slotted flange 562, a washer 564, a nut 566, and a cable 568. The junction 560 includes a body 70 that may be straight or angled having a first end configured to be coupled to the low temperature branch, a second end 574 configured to be coupled to the high temperature branch 520, and a passage 576 extending therethrough for wires/filler to pass through the junction 560. The junction 560 also includes a flange (not shown) surrounding the body 570 configured to abut a low temperature side 532 of a mounting plate. The junction 560 further includes an attachment area 580 on the body 570 between the second end 574 and the flange, and stepped regions 596 and 598. The attachment area 580 may include threads 582 configured to mate with corresponding threads on the nut 566 to secure the junction 560 to the mounting plate. The stepped regions 596 and 598 may receive an end of an overbraid 550, and the overbraid 550 may be secured to the second end 574 in a suitable manner, such as by clamps 552 and 554.

The overbraid 550, which may be a stainless steel overbraid, surrounds one or more cable bundles 556, such as metal braided cable bundles, and as shown two cable bundles that extend through the passage 576, and one or more lengths of filler 558, such as fiberglass filler, and as shown two lengths of filler that extend through the passage 576. The harness may also include one or more reverse braids on the overbraid 550 as shown in FIG. 9 and 10. The lengths of filler 558 extend into the passage 576 through the second end 574, and in one implementation extend through the passage 576 and in another implementation, terminate within the passage 576. Traditional harnesses include filler and wire extending through the overbraid, where the wires extend into a junction and the filler terminates outside of the junction. By extending the lengths of filler 558 into the junction 560, the lengths of filler 558 serve as a strain relief to provide support during flexing and bending of the harness to prevent kinking and prevent the braid strands from separating. The lengths of filler 558 also fill open spaces to limit exaggerated movement.

The harness 510 does not change the electrical circuit, transition assembly structure, material termination or dimensional characteristics of the finished harness, and has no appreciable effects on weight, balance, structural strength, operational characteristics, or other characteristic adversely affecting the products airworthiness, but will improve reliability.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A wire harness for an aircraft comprising:
a high temperature section including one or more high temperature branches, each of the one or more high temperature branches including one or more cable bundles, one or more lengths of filler, and an overbraid surrounding the one or more cable bundles and the one or more lengths of filler, the overbraid including one or more secondary layers of overbraiding at predefined locations along the overbraid;
a low temperature section including one or more low temperature branches; and
a transition assembly separating the high temperature section and the low temperatures section.

2. The wire harness according to claim 1, wherein the one or more secondary layers of overbraiding include a plurality of secondary layers of overbraiding spaced from one another along a length of the overbraid.

3. The wire harness according to claim 1, wherein the one or more secondary layers are formed by back-braiding.

4. The wire harness according to claim 1, wherein the one or more high temperature branch includes a split forming first and second high temperature branches, and wherein each of the first and second high temperature branches has an overbraid with one or more secondary layers of overbraiding.

5. The wire harness according to claim 4, wherein each of the first and second high temperature branches includes a plurality of secondary layers of overbraiding spaced from one another along a length of the overbraid.

6. The wire harness according to claim 1, wherein the transition assembly includes a junction configured to be coupled to a plate in the aircraft, the junction including a body having a first end, a second end, and a passage extending therethrough between the first and second ends, wherein the one or more cable bundles and the one or more lengths of filler extend into the passage.

7. The wire harness according to claim 6, wherein the overbraid is coupled to the second end of the body.

8. The wire harness according to claim 6, wherein the junction additionally includes a flange surrounding the body and configured to abut a side of the plate.

9. The wire harness according to claim 8, wherein the flange includes cutouts on opposite sides thereof extending inward toward the body.

10. A wire harness for an aircraft comprising:
a junction configured to be coupled to a plate in the aircraft, the junction including a body having a first end, a second end configured to extend through an opening in the plate, and a passage extending therethrough between the first and second ends;
one or more cable bundles extending into the passage from the second end of the body;
one or more lengths of filler extending into the passage from the second end of the body; and
an overbraid coupled to the second end of the body surrounding the one or more cable bundles and the one or more lengths of filler.

11. The wire harness according to claim 10, wherein the one or more cable bundles includes two cable bundles and the one or more lengths of filler include two lengths of filler.

12. The wire harness according to claim 10, wherein the lengths of filler extend into the passage and terminate within the passage.

13. The wire harness according to claim 10, wherein the lengths of filler are fiberglass filler.

14. The wire harness according to claim 10, further including one or more secondary layers of overbraiding at predefined locations along the overbraid.

15. The wire harness according to claim 14, wherein the one or more secondary layers of overbraiding include a plurality of secondary layers of overbraiding spaced from one another along a length of the overbraid.

16. The wire harness according to claim 14, wherein the one or more secondary layers are formed by back-braiding.

17. The wire harness according to claim 10, wherein the junction additionally includes a flange surrounding the body configured to abut a side of the plate.

18. The wire harness according to claim 17, wherein the flange includes cutouts on opposite sides thereof extending inward toward the body.

19. The wire harness according to claim 18, wherein the body of the junction includes stepped regions at the second end that receive the overbraid, and wherein the overbraid is secured to the second end at the stepped regions by respective clamps.

20. A method of forming a high temperature section of a wire harness, the high temperature section including one or more high temperature branches including one or more cable bundles and one or more lengths of filler, the method including:
performing a forward braid in a first direction a first predetermined distance around the one or more cable bundles and one or more lengths of filler to form an overbraid;
performing a reverse braid in a second direction opposite the first direction a second predetermined distance; and
performing a forward braid in the first direction the second predetermined distance forming one or more additional layers of braiding.
